(19) United States
(12) Patent Application Publication
(10) Pub. No.: US 2024/0349950 A1
(43) Pub. Date: Oct. 24, 2024

(54) LARDING UTENSIL AND METHODS FOR ITS PRODUCTION AND USE

(71) Applicant: ELIACHAR TECHNOLOGIES DEVELOPMENTS LTD., Haifa (IL)

(72) Inventors: Eliahu ELIACHAR, Haifa (IL); Nir LILACH, Kfar Yehoshua (IL)

(21) Appl. No.: 18/433,976

(22) Filed: Feb. 6, 2024

Related U.S. Application Data
(60) Provisional application No. 63/461,283, filed on Apr. 23, 2023.

(51) Int. Cl. A47J 43/16

(52) U.S. Cl. CPC A47J 43/16

(57) ABSTRACT

The present invention discloses a simple, quick- and intuitively operated larding utensil for interlacing meat with fat. The utensil is made of food-compatible material with dishwasher proof mechanism. The present invention also discloses method of its use and assembly.

### CROSS REFERENCE

This application is a Convention Filing of U.S. Provisional Patent Application No. 63/461,283 with the filing date of Apr. 23, 2023, the contents of which are all incorporated herein by reference in their entirety.

### FIELD OF THE INVENTION

The invention pertains to a larding utensil and methods for its production and use.

### BACKGROUND OF THE INVENTION

Larding utensil, also known as a larding pin or larding needle, is an instrument utilized for interlacing meat with strips of flavor-imparting substances such as bacon or fat. Many patents were filed from the 1900's, including e.g., DE8816343U1 and DE3841504C2, both disclose a device for curing and filling of food comprising a steel or plastic tube which is roughened and sharpened at the front opening as a round or rotary cutter.

Larding devices known in the art are characterized by two drawbacks: (i) extracted substance is of variable volumes, so that the meat is interlaced unevenly; and (ii) use of a larding device requires both the right and left hands. This operation is inconvenient and more importantly, increase variability of the extracted volumes. A simple, quick and intuitively operated larding utensil for the use in interlacing meat with one or more of metered-dose portions of larding substance is not disclosed in the art. Hence, a larding utensil of the present invention is still a long-felt need.

### SUMMARY OF THE INVENTION

It is hence one object of the invention to disclose a simple, quick- and intuitively operated larding utensil, made of food-compatible material with dishwasher proof mechanism.

It is another object of the invention to disclose a larding utensil characterized by the features above, and provided with an elongated hollow body (4, see FIGS. 1-16) made of food-compatible and dishwasher proof materials. The body contains, inter alia, a pusher (1) which is both held by and is linearly-reciprocatable through an open bore cap (2), reversibly affixed to the body. When released, pusher 1 protrudes out of cap 2 at the proximal end of the utensil (4P). Pusher 1 is an elongated member interconnected with a plunger 6, being enveloped at its distal end (8D) by a hollow tip 8 of the body (4). Also, within said hollow body 4 there is provided slider 3, with its distal portion facing the lower portion of pusher 1, and a spring positioner 5 at the distal portion of the body (4). Spring positioner 5 is held distally of the slider (3), circling plunger 6, with plunger 6 configured to reciprocate linearly along tip 8.

It is another object of the invention to disclose a larding utensil as disclosed above, wherein the utensil is further characterized by two configurations: (a) normally-released (201) and (b) depressed (202). At the second configuration, namely, when pusher 1 is pressed downwards (distally, 103), slider 3 compresses spring 7. Slider 3 and spring 7, which normally fill body cavity 4B, are now pressed into the lower (distal) body cavity 4C. Plunger 6 hence fills the inner volume 8V of tip 8, causing plunger 6 to protrude from orifice 8E at the distal end 8D of tip 8.

It is another object of the invention to disclose a method of interlacing meat with fat. The method comprises inter alia steps of (a) providing a larding utensil as defined in any of the above adjacent to, substantially perpendicular to, and above a fat portion to be used for inserting into the meat. The device is positioned so that orifice 8E is close to the fat, whilst pusher 1 is in its normally-released configuration. In step (b), piercing the fat to ascertain its depth by a gentle movement (102) of the whole utensil downward into the fat, whilst pusher 1 is still unpressed, so that tip 8 is filled with an amount of fat 8L. In step (c), moving the utensil with the contained fat (8L) upward (112), leaving a void volume in the fat F8 with the fat 8L being confined within the tip's distal end. In step (d), moving the larding utensil (122) until it is adjacent to, substantially perpendicular to and above a first meat location 1072 with the orifice 8E close to the meat in order to insert the confined fat (8L) into the meat, pusher 1 is still in its normally-released configuration. In step (c), piercing (132) the meat downwardly, at a first location in the meat (1702; the orifice (8E) is located at a certain depth in the meat; pusher 1 still is in its normally-released configuration. In step (f), moving the larding utensil upward (142), removing it from the meat, whilst depressing pusher 1, so that the fat portion 8L remains within the meat at the first location (1702). Then, step (g), moving the larding utensil outside the meat, whilst releasing (152) pusher 1 so that the larding utensil is ready to either (a) piercing a second portion of fat in a second location of the fat (1703, see FIG. 17), or, (b) if a second portion of fat (8L2) is still contained within tip 8, to pierce the meat again, at a second location 1704, see FIG. 17), inserting into the meat a second portion of fat (8L2).

It is another object of the invention to disclose a method of assembling a larding utensil. The method is characterized by steps as follows: providing an elongated hollow body (4); reversibly affixing an open bore cap (2) to said body; holding an elongated pusher (1) by, and linearly-reciprocating the same through an open bore cap (2); providing said pusher 1, when released, to protrude out of cap 2 at the proximal end of the utensil (4P); interconnecting pusher 1 with a plunger 6, and enveloping the same at its distal end (8D) by a hollow tip 8 of the body (4); providing a slider 3 within said hollow body 4, with its distal portion facing the lower portion of pusher 1, and a spring positioner 5 at the distal portion of the body (4); and, holding a spring positioner 5 distally of the slider (3), circling plunger 6, and configuring plunger 6 to reciprocate linearly along tip 8.

It is another object of the invention to disclose a method as defined above, wherein the method further is characterized by step of providing the utensil with two configurations: normally-released (201) and depressed (202) so that when pusher 1 is pressed downwards (distally, 103) slider 3 compresses spring 7; slider 3 and spring 7, which normally fill body cavity 4B, are hence pressed into the lower (distal) body cavity 4C; plunger 6 fills the inner volume 8V of tip 8, causing plunger 6 to protrude from orifice 8E at the distal end 8D of tip 8.

### BRIEF DESCRIPTION OF THE DRAWINGS

An example of the invention will now be described with reference to the accompanying diagrammatic drawings, wherein:

FIGS. 1-2, 3A-3D, 4A-4B, 5A-5B, 6A-6B, 7A-7B, 8A-8B and FIGS. 16A-C schematically illustrating in a non-limiting manner a larding utensil according to an embodiment of the invention;

FIGS. 9A-9B, 10-10B, 11A-11B, 12A-12B, 13A-13B, 14A-14B and 15A-15B schematically present, in a non-limiting and out-of-scale manner, a method of interlacing metered-dose portions of fat in a meat according to an embodiment of the invention; and

FIG. 17, schematically illustrating meat, with fat inserted into it by a larding utensil according to an embodiment of the invention.

### DETAILED DESCRIPTION OF THE PREFERRED EMBODIMENT

The present invention aims at providing a larding utensil characterized by a mechanism which enables larding of a predefined metered-dose volume, is single-hand operated, and enables meat to be interlaced/larded. The utensils may incorporate additional mechanism for adjusting the harvested lard length and a mechanism for amplification of the actuation button linear movement, to lard thrusting piston linear movement

While terms such as “meat”, “food” and “feedstuff” are often used to describe foods given to farm livestock and non-human mammals the term “food” can be applied equally to food given to such animals and to man so that when the terms “food product”, “product” or “foodstuff” are used in this Specification, they are to be taken as meaning a food ingredient or food which can be used in the feeding of nonhuman mammals and of humans. The term “meat” may include poultry, fish, meat-like food stuff, cultured meat, vegan meat, like microorganism-origin, vegetable-origin or stem-cells based food, and meat from a non-animal origin. The term “meat” may also include the edible cuts of portions of meat obtained from the organs, skin, skeletal muscle or like edible portions of mammals such as cattle, hogs, sheep, fowl such as chicken and fish.

How about a nonfood use the terms “lard” will be used hereinafter to refer natural lard, rearranged lard, rendered pork fat, and lard-mimics, including lard from poultry, fish, meat-like or fat-like or seasoned at least partially water immiscible-like lard, microorganism-originated lard, vegetable-originated lard, stem cells-originated lard, and lard-like products from a non-animal, flavored edible compositions, and other food additives, such as taste improving agents, vitamins etc.

The term “about” refers to a value being ±20% of the defined measure.

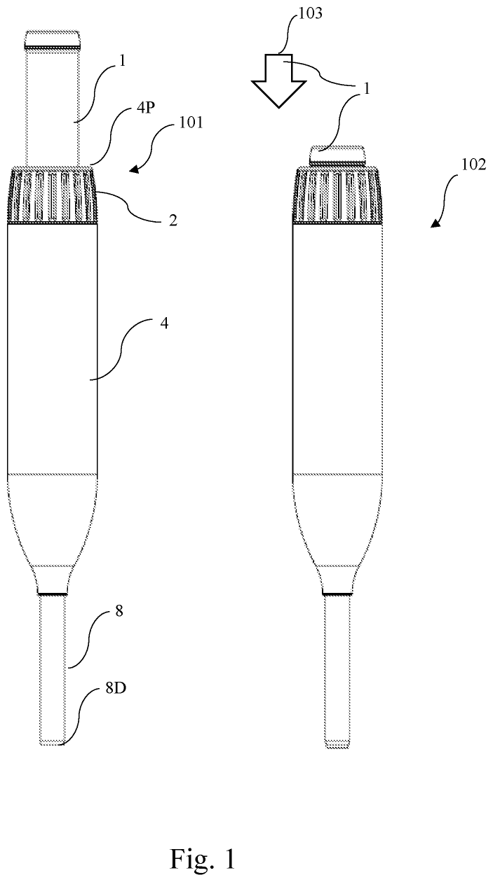

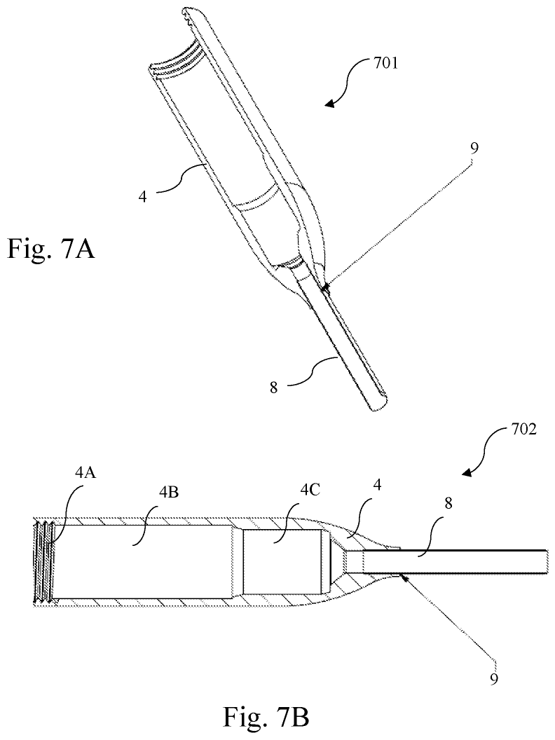

Reference is now made to FIGS. 1-17, schematically illustrating in a non-limiting manner a larding utensil according to an embodiment of the invention. The device comprises a body (4), e.g., a substantially cylindrical elongated hollow body (4) made of food-compatible and dishwasher proof materials such as plastic and stainless steel that is convenient to hold and easy to manipulate. Pusher (1) is held by and is linearly-reciprocatable through an open bore cap (2) reversibly affixed to the body, e.g., by means of threads (4A) on body (4) and open-bore cap (2). Pusher 1, protruding out of cap 2 at the proximal end of the utensil (4P), is an elongated member interconnected with a piston-like plunging member 6, plunger 6 being enveloped at its distal end (8D) by a substantially cylindrical hollow tip 8 of the body (4). Also within hollow body 4 is slider 3, with its distal portion facing the lower portion of pusher 1, and a spring positioner 5 at the distal portion of the body (4). Spring positioner 5 is held distally of the slider (3), circling plunger 6, with plunger 6 configured to reciprocate linearly along tip 8.

FIG. 1 shows the larding utensil in two of its configurations, namely its normally-released (101) configuration and a depressed (102) configuration. In one embodiment of the invention, pusher 1 is a thumb switch-like button, configured to be pressed (103) and to push plunger 6 towards the distal portion 8D of tip 8. Additionally, or alternatively, pusher 1 is a knob maneuverable along the side of body 4. Additionally, or alternatively, pusher 1 is a rotatable screw-like member. Additionally, or alternatively, pusher 1 is actuated by one or more cog wheels, by a rack and pinion, or by any other suitable mechanism. Additionally, or alternatively, pusher 1 is configured to be operated in a manner selected from a group consisting of manually, electrically, mechanically, pneumatically, hydraulically or any combination thereof.

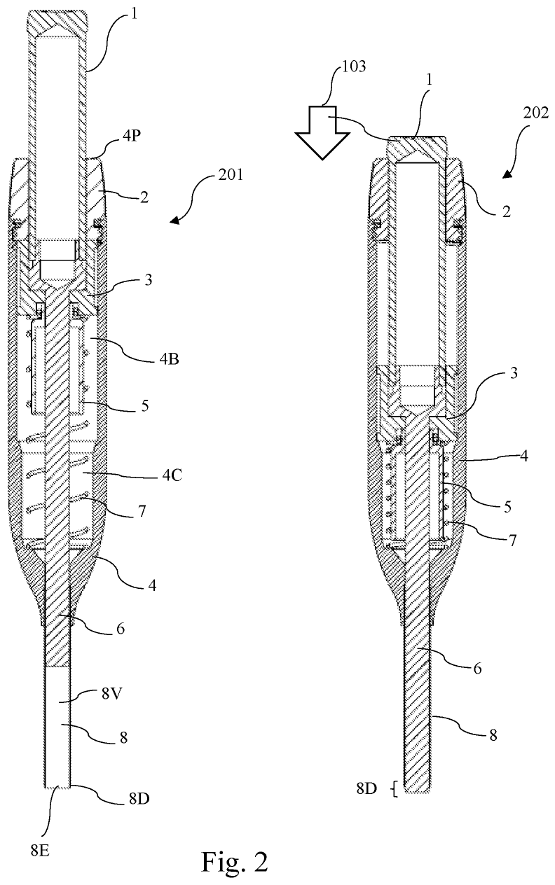

FIG. 2 schematically illustrates a cross section of a larding utensil in its aforesaid two configurations: normally-released (201) and depressed (202). When pusher 1 is pressed downwards (i.e., distally, 103) slider 3 compresses spring 7. Slider 3 and spring 7, which normally fill body cavity 4B, are thus pressed into the lower (distal) body cavity 4C. Plunger 6 now fills the inner volume 8V of tip 8, causing plunger 6 to protrude from orifice 8E at the distal end 8D of tip 8. It is in the scope of the invention wherein tip 8 is shaped as an elongated (linear-) member, curved member, rigid or semi-rigid member, and having cither a circular or polygonal cross section.

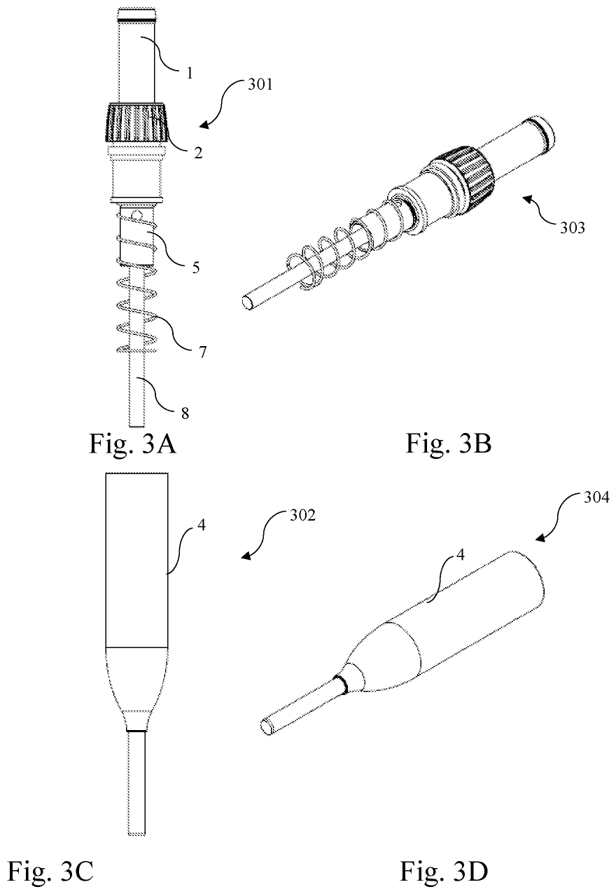

FIG. 3A-D schematically depicts a larding utensil and its two main subunits. FIGS. 3A and 3C, show a front view of inner actuating and larding unified mechanisms 301 (FIG. 3A) and their housing 302 (FIG. 3C); while FIGS. 3B and 3D show a perspective view of inner actuating and larding unified mechanisms 303 (FIG. 3B) and their housing 304 (FIG. 3D).

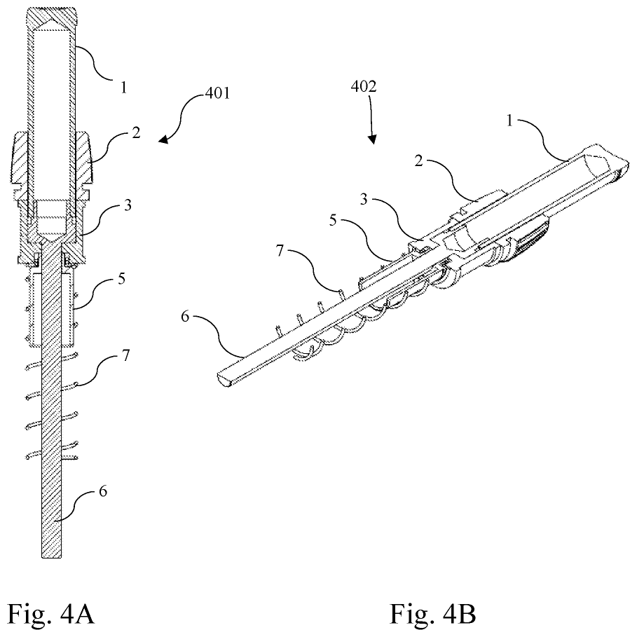

FIG. 4A-B similarly presents cross sections of the larding utensil in front view (401) (FIG. 4A) and perspective view (402) (FIG. 4B).

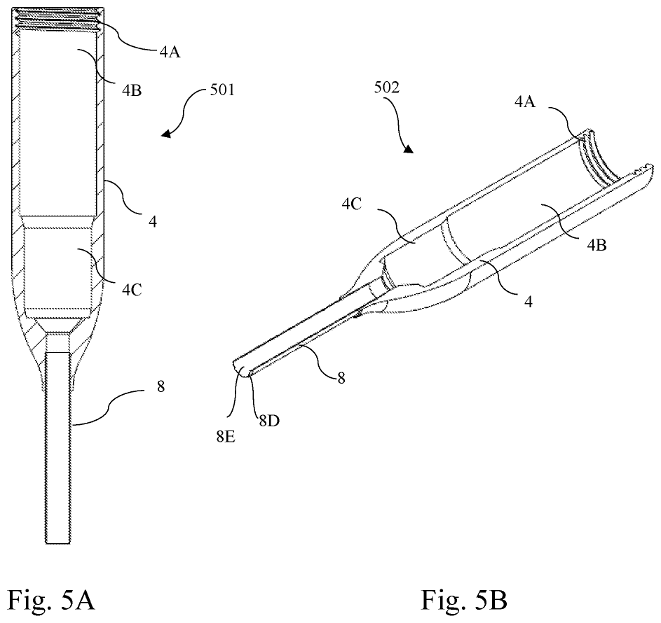

FIG. 5A-B shows a cross section (501, FIG. 5A) and a perspective view (502, FIG. 5B) of laterally sliced half of body 4. In some embodiments of the invention, body 4 comprises a few interconnected cavities, e.g., upper (proximal) cavity 4B and lower (distal) cavity 4C (see FIG. 2).

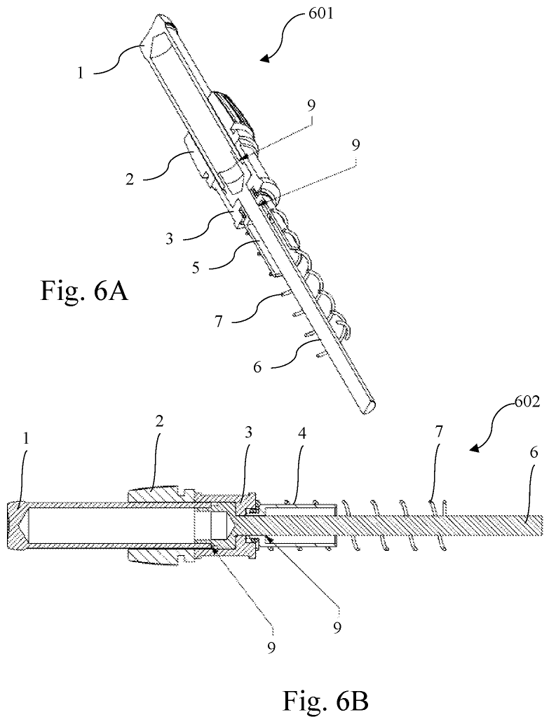

Reference is now made to FIGS. 6A-B and 7A-B, each of which schematically illustrates both a perspective view of sections 601, 701 taken along a lateral cutting plane and cross sections 602, 702 of the inner mechanism and body, respectively. According to some embodiments of the invention, provided here in a non-limiting manner, modules of the body and/or mechanism can be welded or otherwise interconnected at predetermined locations, such as welding spots 9.

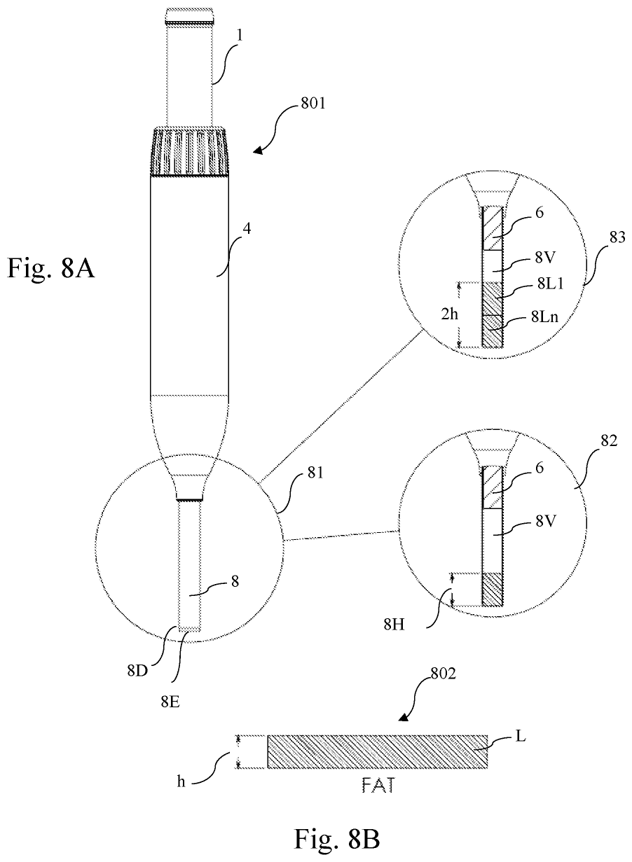

FIG. 8A-B schematically depicts a larding utensil 801, having a pointed tip 8 at its distal end (8D) and rounded orifice 8E. The diameter of the orifice 8E ranges from about 2 mm to about 10 mm. Larding utensil 801 is configured for inserting into meat, or any other at least one first material or first foodstuff, small pieces, drops or the like of at least one flavor-imparting substance such as bacon, lard or fat (see L, 802) or any other at least one second material such as a second foodstuff, having a certain height (h), e.g., 1 to about 30 mm. The area inside circle 81, showing the distal portion 8D and the orifice 8E of tip 8 is shown enlarged inside circles 82 and 83. Circle 82 shows a cross section of tip 8, comprising (from the top downward) the plunger (6), the void volume (8V) of the tip (8) and a fat portion of height h (8H) contained within the void volume 8V. Circle 83 similarly shows a cross section of tip 8, comprising (from the top downward) plunger (6), the void volume (8V) of the tip (8), a first contained fat portion (8L1) and an n^{th} contained portion (8Ln), each of which is of height h for a total height of 2h. In some embodiments of the invention, n ranges from 0 to 10 or more. As an example, n equals 2 or 3. As the predefined volume of fat contained within the tip varies in a non-limiting manner from e.g., (□r2h) 3.14×1²×3 (about 9 mm³ or less) to 3.14×13²×13 (about 5.3 cm³ or more), e.g., about 0.03 ml, about 0.05, about 2.5 ml, about 4 ml etc., and tip void volume (8V) may vary in a non-limiting manner from, e.g., from about 5 ml or less to about 15 ml or more, a limited press on the pusher (1) inserts into the meat a first predefined portion of fat, a second further press inserts a second predefined portion of fat, and so on, e.g., 1 to 5 times or more. The fat may be pushed out of tip 8 in portions according to the user preference. According to an embodiment of the invention, lard is a viscus (hard) gel-like, or solid fat-like material, which is not an oil-like fluid flowing freely. It is acknowledged in this respect that according to an embodiment of the invention, device's volume is about 2 to about 10 time smaller than other commercially available larding needles configured to lard about 1 to about 2 oz.

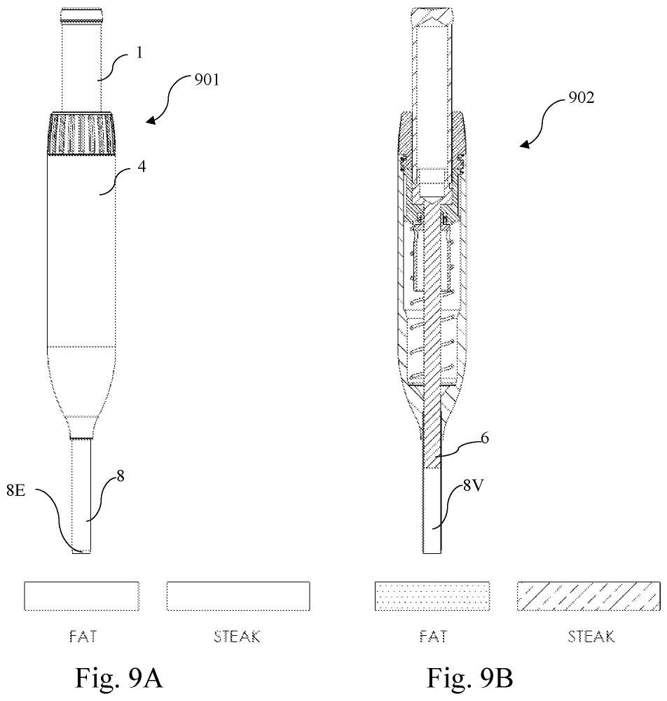

FIGS. 9 to 15 schematically present, in a non-limiting and out-of-scale manner, a method of inserting into meat, or any other at least one first material or first foodstuff, small pieces, drops (and such 3D either amorphous globules or textured beads) of flavor-imparting substances such as bacon, lard or fat. Images 901, 1001, 1101, 1201, 1301, 1401 and 1501 (FIGS. 9A, 10A, 11A, 12A, 13A, 14A, 15A) depict a front view of larding utensil according to an embodiment of the invention at the various steps of inserting the lard or other fat into the meat, here a steak. Images 902, 1002, 1102, 1202, 1302, 1402 and 1502 (FIGS. 9B, 10B, 11B, 12B, 13B, 14B, 15B) depict a lateral cross-section of the same.

In a first step (FIG. 9A-B), the device is adjacent to, substantially perpendicular to and above a fat portion to be used for inserting into the meat, here a steak portion; orifice 8E is close to the fat. Pusher 1 is in its normally-released configuration.

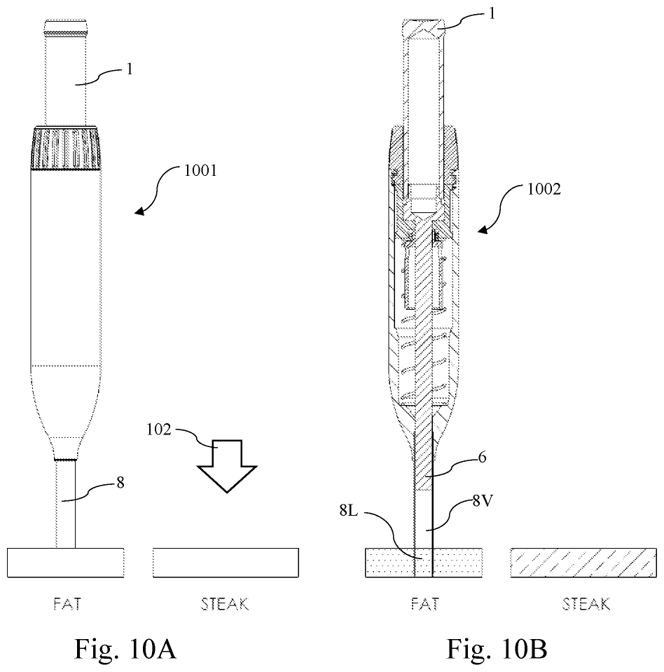

In a second step (FIG. 10A-B), the tip 8 is piercing the fat to ascertain its depth by a gentle movement (102) of the whole utensil downward into the fat, whilst pusher 1 is still unpressed, so that tip 8 is filled with an amount of fat 8L.

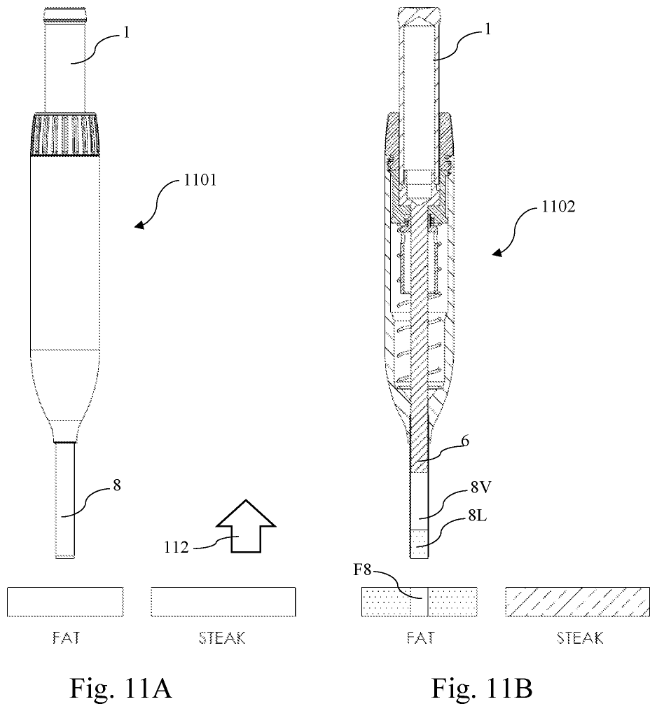

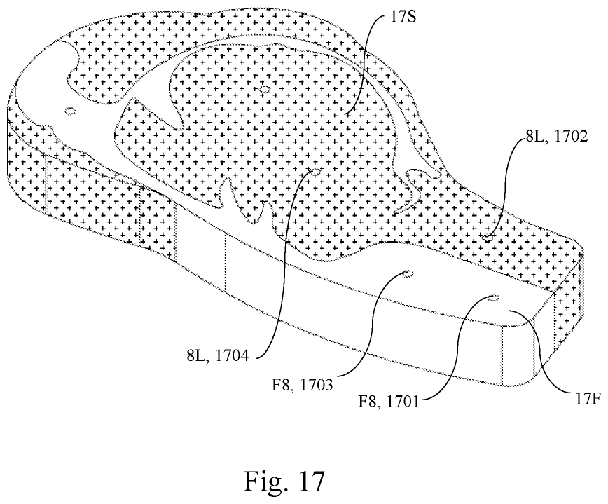

In a third step (FIG. 11A-B), the utensil with the contained fat (8L) is moved upward (112), leaving a void volume in the fat F8 (see also 1071, FIG. 17), with the fat 8L being confined within the tip's distal end.

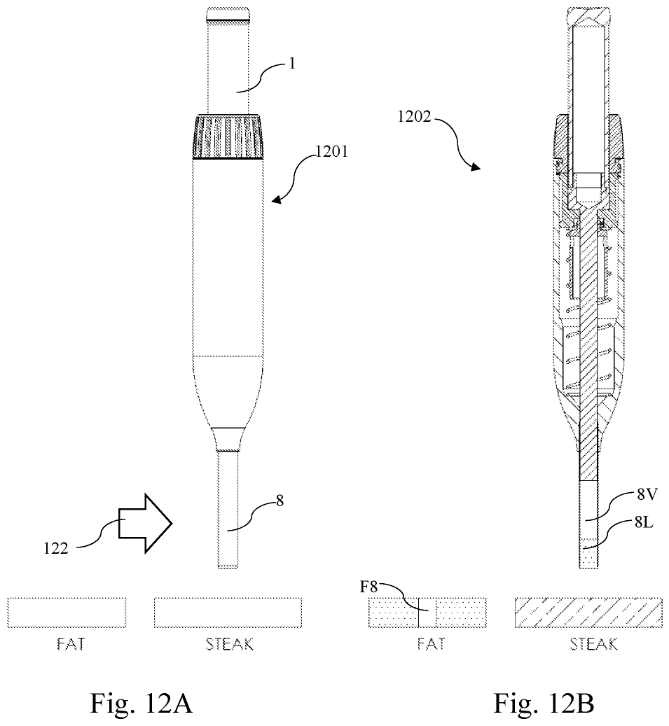

In a fourth step (FIG. 12A-B), the larding utensil is now moved (122) until it is adjacent to, substantially perpendicular to and above a first meat location 1072 (see FIG. 17) with the orifice 8E close to the meat in order to insert the confined fat (8L) into the meat. Pusher 1 is still in its normally-released configuration.

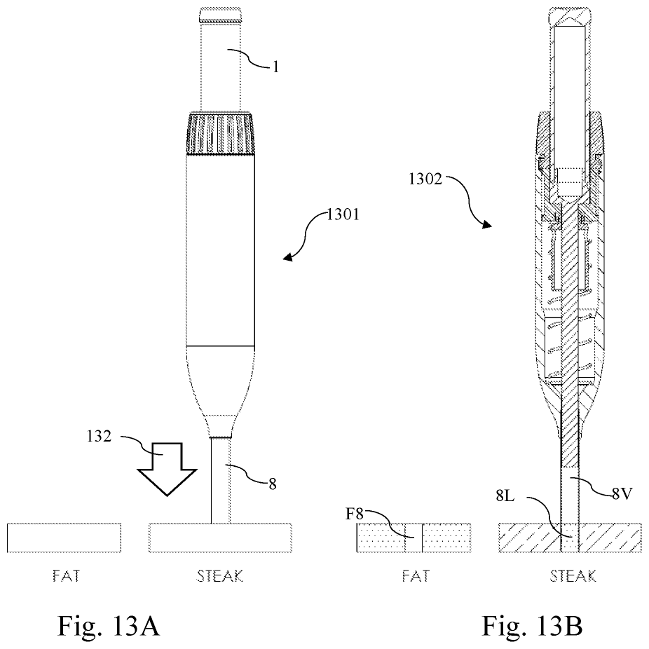

In a fifth step (FIG. 13A-B), the larding utensil pierces (132) the meat downwardly, at a first location in the meat (1702, see FIG. 17); the orifice (8E) is located at a certain depth in the meat. The depth in the meat is a function of height (h) of the contained fat 8L. Pusher 1 still is in its normally-released configuration.

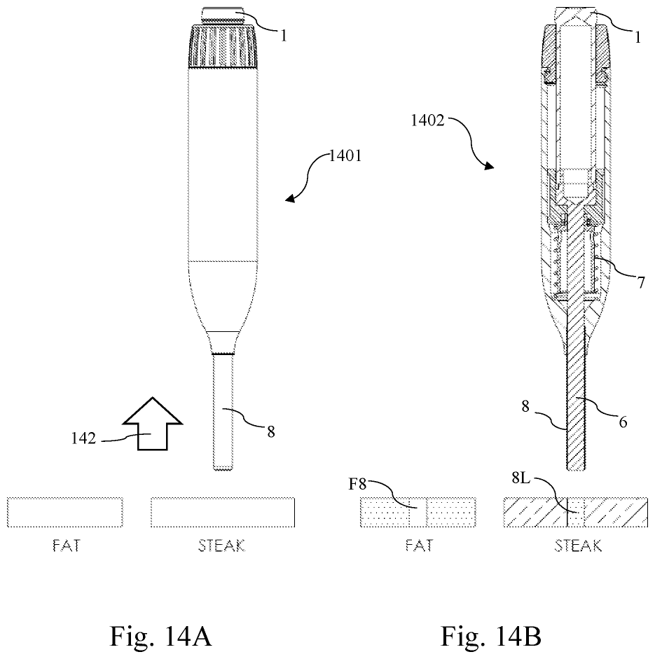

In a sixth step (FIG. 14A-B), the larding utensil is now being moved upward (142), removing it from the meat, whilst pusher 1 is gently depressed, so that the fat portion 8L is pushed into the meat and remains within the meat at the first location (1702, see FIG. 17).

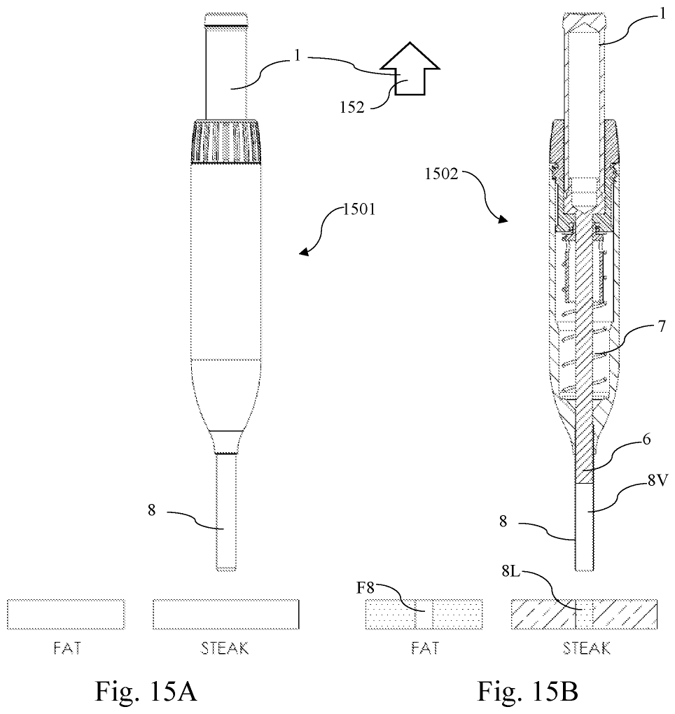

In a last step (FIG. 15A-B), with larding utensil outside the meat, pusher 1 is released (152) so that the larding utensil is ready to cither (a) pierce a second portion of fat in a second location of the fat (1703, see FIG. 17), or, (b) if a second portion of fat (8L2) is still contained within tip 8, to pierce the meat again, at a second location 1704, see FIG. 17), inserting into the meat a second portion of fat (8L2), and so on.

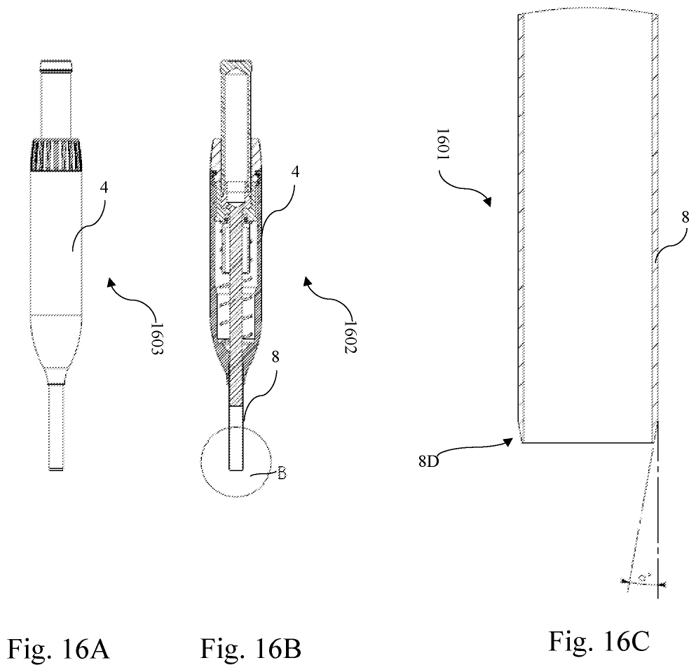

Reference is now made to FIGS. 16A-C, where FIG. 16A schematically illustrates a plan view (1603) of a larding utensil with body 4. FIG. 16B schematically illustrates a cross-section (1602) of the larding utensil with body 4 and tip 8; while FIG. 16C schematically illustrates a cross-section (1601) of the area inside circle B of FIG. 16B, showing the pointed distal end (8D) of a tip 8 in a larding utensil according to an embodiment of the invention. The angle varies from about 10 degrees to about 40 degrees, e.g., 30°.

Reference is now made to FIG. 17, schematically illustrating meat, here a steak, with fat inserted into it by the larding utensil of the present invention. The steak comprises fat portions (17F) and meat (protein-rich) portions (17S). The larding utensil pierced the fat portion 17F of the steak at a first location 1701, to provide the fat 8L inserted at a first meat location 1702. In a second cycle, the larding utensil pierced fat portion 17F at a second location 1703, to insert the fat 8L into the meat at a second meat location 1704, and so on.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate, to a showing of the superiority and inferiority of the invention. Although one or more embodiments of the present inventions have been described in detail, it should be understood that the various changes, substitutions, and alterations could be made hereto without departing from the spirit and scope of the invention.

1. A larding utensil characterized by an elongated hollow body (4) made of food-compatible and dishwasher proof materials; said body containing a pusher (1) held by and is linearly-reciprocatable through an open bore cap (2) reversibly affixed to said body; when released, pusher 1 protrudes out of cap 2 at the proximal end of the utensil (4P); pusher 1 is an elongated member interconnected with a plunger 6, being enveloped at its distal end (8D) by a hollow tip 8 of the body (4); also within said hollow body 4 is slider 3, with its distal portion facing the lower portion of pusher 1, and a spring positioner 5 at the distal portion of the body (4); spring positioner 5 is held distally of the slider (3), circling plunger 6, with plunger 6 configured to reciprocate linearly along tip 8.

2. The larding utensil of claim 1, wherein said utensil is further characterized by two configurations: normally-released (201) and depressed (202); when pusher 1 is pressed downwards (distally, 103) slider 3 compresses spring 7; slider 3 and spring 7, which normally fill body cavity 4B, are hence pressed into the lower (distal) body cavity 4C; plunger 6 hence fills the inner volume 8V of tip 8, causing plunger 6 to protrude from orifice 8E at the distal end 8D of tip 8.

3. A method of interlacing meat with fat, wherein said method comprises steps as follows:
a. providing a larding of claim 1 adjacent to, substantially perpendicular to and above a fat portion to be used for inserting into the meat, orifice 8E is close to the fat, pusher 1 is in its normally-released configuration;
b. piercing the fat to ascertain its depth by a gentle movement (102) of the whole utensil downward into the fat, whilst pusher 1 is still unpressed, so that tip 8 with an amount of fat 8L;
c. moving the utensil with the contained fat (8L) upward (112), leaving a void volume in the fat F8 with the fat 8L being confined within the tip's distal end;
d. moving said larding utensil (122) until it is adjacent to, substantially perpendicular to and above a first meat location 1072 with the orifice 8E close to the meat in order to insert the confined fat (8L) into the meat, pusher 1 is still in its normally-released configuration;
e. piercing (132) the meat downwardly, at a first location in the meat (1702; the orifice (8E) is located at a certain depth in the meat; pusher 1 still is in its normally-released configuration;
f. moving the larding utensil upward (142), removing it from the meat, whilst depressing pusher 1, so that the fat portion 8L remains within the meat at the first location (1702); and
g. moving said larding utensil outside the meat, whilst releasing (152) pusher 1 so that the larding utensil is ready to either (a) piercing a second portion of fat in a second location of the fat (1703, see FIG. 17), or, (b) if a second portion of fat (8L2) is still contained within tip 8, to pierce the meat again, at a second location 1704, see FIG. 17), inserting into the meat a second portion of fat (8L2).

4. A method of assembling a larding utensil, characterized by steps as follows:
a. providing an elongated hollow body (4);
b. reversibly affixing an open bore cap (2) to said body;
c. holding an elongated pusher (1) by, and linearly-reciprocating the same through an open bore cap (2);
d. providing said pusher 1, when released, to protrude out of cap 2 at the proximal end of the utensil (4P);
e. interconnecting pusher 1 with a plunger 6, and enveloping the same at its distal end (8D) by a hollow tip 8 of the body (4);
f. providing a slider 3 within said hollow body 4, with its distal portion facing the lower portion of pusher 1, and a spring positioner 5 at the distal portion of the body (4);
g. holding a spring positioner 5 distally of the slider (3), circling plunger 6, and configuring plunger 6 to reciprocate linearly along tip 8.

5. The method of assembling a larding utensil of claim 4, characterized by step of providing said utensil with two configurations: normally-released (201) and depressed (202) so that when pusher 1 is pressed downwards (distally, 103) slider 3 compresses spring 7; slider 3 and spring 7, which normally fill body cavity 4B, are hence pressed into the lower (distal) body cavity 4C; plunger 6 fills the inner volume 8V of tip 8, causing plunger 6 to protrude from orifice 8E at the distal end 8D of tip 8.
